(19) United States
(12) Patent Application Publication
(10) Pub. No.: US 2023/0407896 A1
(43) Pub. Date: Dec. 21, 2023

(54) BIDIRECTIONAL CLIP FOR VEHICLE

(71) Applicant: DAEHAN SOLUTION CO., LTD, Incheon (KR)

(72) Inventors: Choong HO KWON, Seoul (KR); Jong Woo KIM, Incheon (KR)

(73) Assignee: DAEHAN SOLUTION CO., LTD, Incheon (KR)

(21) Appl. No.: 18/208,382

(22) Filed: Jun. 12, 2023

(30) Foreign Application Priority Data
Jun. 21, 2022 (KR) 10-2022-0075609

(51) Int. Cl. F16B 5/06; F16B 21/08

(52) U.S. Cl. CPC F16B 5/0642; B60R 13/0815; F16B 21/082

(57) ABSTRACT

A bidirectional clip for a vehicle, in which elastic stopping protrusions are integrally formed in pillars protruding outward from both surfaces of a base, assembly may be immediately performed even with the elastic stopping protrusion formed on any side of the base, and thus assembly efficiency can be improved. In particular, the bidirectional clip for a vehicle, in which at least two, preferably, four to six elastic stopping protrusions protrude from the pillars at regular intervals, and thus when assembly is performed using the bidirectional clip, the assembly can be easily and conveniently performed regardless of an assembly direction. Further, the bidirectional clip for a vehicle, in which the elastic stopping protrusions protrude from both sides of the base, and thus two components can be fixedly assembled with each other using the one bidirectional clip.

### CROSS-REFERENCE TO RELATED APPLICATION

This application claims priority to and the benefit of Korean Patent Application No. 10-2022-0075609 filed on Jun. 21, 2022, the disclosure of which is incorporated herein by reference in its entirety.

### BACKGROUND OF THE INVENTION

### 1. Field of the Invention

The present disclosure relates to a bidirectional clip for a vehicle, and more particularly, to a bidirectional clip in which elastic stopping protrusions are formed on both surfaces of a base, the elastic stopping protrusions are fitted through mounting holes, and the elastic stopping protrusions are deformed and then return to original states thereto, and thus are caught by edges of the mounting holes, so that a worker can easily assemble the bidirectional clip using the elastic stopping protrusions present in a convenient position while holding the bidirectional clip in any direction, and in some cases, can conveniently use the bidirectional clip even when two members need to be assembled using one clip.

### 2. Discussion of Related Art

In general, in vehicles, as illustrated in FIGS. 1 and 2, as in a case in which a hood insulator I is mounted on a hood H or a dash outer insulator is mounted on a dash panel, a clip C assembled by being fitted through a member to be mounted and then being forcibly fitted in a mounting hole formed in a vehicle body or the like or assembled by being forcibly fitted in a state in which a member and a panel overlap each other is used. When the clip C is assembled, the clip C may be easily assembled without tools, is thus widely used in the vehicle industry, and is manufactured and used in various shapes as in (Patent Document 1) to (Patent Document 3) as follows.

Patent Document 1: Korean Patent Application Publication No. 10-2017-0073144

A fixing clip for a vehicle for assembling vehicle components is disclosed. The fixing clip for a vehicle may include a clip body and a clip head made of a plastic material. The clip body includes a stopping part that is slid into a coupling hole formed in a vehicle component and fitted in the vehicle component and a fastening part extending from an upper portion of the stopping part and having a screw thread formed therein. The clip head is coupled to the fastening part through a screw-coupling manner and fixes the clip body to the vehicle component. In this way, the fixing clip is coupled to the vehicle component in a fitting coupling manner rather than a screw coupling manner, and the clip body and the clip head are coupled to each other in the screw coupling manner for firm fixing coupling between vehicle components. Accordingly, since a fastening state with the vehicle component may be stably maintained even when the vehicle component is expanded or contracted due to a high painting temperature during a painting process, assemblability is improved, a process time is shortened, and the clip is easily detached.

Patent Document 2: Korean Patent No. 10-1803882

A clip for a vehicle includes a fitting protrusion fitted in communicated fitting holes when components overlap each other and the fitting holes formed in the components coincide with and communicate with each other, a head part formed integrally with the fitting protrusion and supported by a component on a side in which the fitting protrusion is fitted after the fitting protrusion is fitted in the communicated fitting hole, a stopping protrusion that protrudes from the fitting protrusion, has elasticity, is supported by a component on an opposite side to the side in which the fitting protrusion is fitted after the fitting protrusion passes through the communicated fitting hole when the fitting protrusion is fitted in the communicated fitting hole, and couples the overlapping components, and a stopping rib that is formed spaced apart from the head part, is spaced a distance from the head part to the stopping protrusion or more, and couples another overlapping components to the overlapping components. Thus, the stopping protrusion and the stopping rib formed an outer circumferential surface of the fitting protrusion fitted in and passing through the communicated fitting hole of the overlapping components are positioned at different distances, so that the overlapping components having different thicknesses can be coupled using one clip, and thus costs can be reduced.

Patent Document 3: Korean Patent No. 10-1377064

The present disclosure provides a mat fixture for a vehicle, wherein in fixing a mat by fitting a fixing cover in a fixing protrusion in the form of division pins, a constant interval between the division pins is maintained by further forming an interval maintaining protrusion on the fixing cover, and thus due to the interval between the division pins, the division pins can be prevented from being damaged or losing a stopping function due to repeated deformation. The mat fixture for a vehicle includes a fixing protrusion provided with division pins and a fixing cover that fixes a vehicle mat while surrounding the division pins, wherein the interval maintaining protrusion fitted between the division pins at a center in which the division pins are fitted to maintain an interval therebetween is further formed in the fixing cover.

As illustrated in FIG. 3, the clip C according to the related art has a stopping protrusion protruding from a center of a base surface in close contact with a member and is assembled by being fitted in a mounting hole to be coupled.

### RELATED ART DOCUMENT

### Patent Document

(Patent Document 1) Korean Patent Application Publication No. 10-2017-0073144 (published on Jun. 28, 2017)
(Patent Document 2) Korean Patent Registration No. 10-1803882 (registered on Nov. 27, 2017)
(Patent Document 3) Korean Patent Registration No. 10-1377064 (registered on Mar. 17, 2014)

### SUMMARY OF THE INVENTION

However, a clip according to the related art has the following inconveniences.

(1) When a worker grips the clip, fits the clip in a mounting hole, and presses the clip, assembly is easily performed, but work is inconvenient due to a directionality in which the clip should be fitted in a predetermined direction.

(2) In particular, like a case in which the assembly is performed in a state in which one hand grips a component to be assembled and the other hand grips the clip, it is difficult to assemble the clip according to the directionality in accordance with the assembly direction while the clip is gripped by the one hand.

(3) Further, in this way, when the assembly is performed while the clip is gripped by the one hand, and when the assembly direction is not correct, the worker should perform the assembly while turning a direction of the clip only by the hand gripping the clip, and thus an assembly operation is inconvenient.

(4) Meanwhile, like a panel, a place in which two components assembled using the clip should be necessarily connected to each other occurs in the components, but like the clip according to the related art, the clip that is assembled on only one side cannot assemble the two components with each other at once.

The present disclosure is directed to providing a bidirectional clip for a vehicle, in which elastic stopping protrusions are integrally formed in pillars protruding outward from both surfaces of a base, assembly may be immediately performed even with the elastic stopping protrusion formed on any side of the base, and thus assembly efficiency can be improved.

The present disclosure is directed to also providing a bidirectional clip for a vehicle, in which at least two, preferably, four to six elastic stopping protrusions protrude from the pillars at regular intervals, and thus when assembly is performed using the bidirectional clip, the assembly can be easily and conveniently performed regardless of an assembly direction.

The present disclosure is directed to also providing a bidirectional clip for a vehicle, in which the elastic stopping protrusions protrude from both sides of the base, and thus two components can be fixedly assembled with each other using the one bidirectional clip.

A bidirectional clip for a vehicle, including a base (100), is configured wherein the base (100) includes two pillars (110) protruding outward from central portions of both surfaces of the base (100), and at least two elastic stopping protrusions (120) spread outward from ends of the pillars (110) toward the base (100), the same interval being formed between the two adjacent elastic stopping protrusions (120) with respect to the pillars (110).

Four to six elastic stopping protrusions (120) may be formed at regular intervals with respect to the pillars (110).

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a side view of a portion of a vehicle, illustrating a mounting position of a hood insulator fixed with a clip according to the related art;

FIG. 2 is a front view of the vehicle, illustrating a mounting state of the hood insulator fixed with the clip according to the related art;

FIG. 3 shows views illustrating an example of the clip according to the related art, in which FIG. 3A is a perspective view and FIG. 3B is a cross-sectional view;

FIG. 4 shows views illustrating a bidirectional clip according to the present disclosure, in which FIG. 4A is a perspective view and FIG. 4B is a plan view;

FIG. 5 shows views illustrating a state in which a dash insulator is mounted with the bidirectional clip according to the present disclosure, in which FIG. 5A is a front view of the dash insulator, FIG. 5B is a cross-sectional view of a dash panel, illustrating a position that is to be fixed with the bidirectional clip, FIG. 5C is a cross-sectional view illustrating a state in which the dash insulator is in close contact with the dash panel, and FIG. 5D is a cross-sectional view illustrating a state fixed with the bidirectional clip according to the present disclosure; and

FIG. 6 shows views illustratively illustrating a state in which a wiring is fixed to an elastic stopping protrusion that is not used in a state in which the dash insulator is mounted on the dash panel as illustrated in FIG. 5, in which FIG. 6A is an enlarged front view illustrating a portion of the dash insulator on which the wiring is mounted and FIG. 6B is a cross-sectional view illustrating a state in which the wiring is mounted.

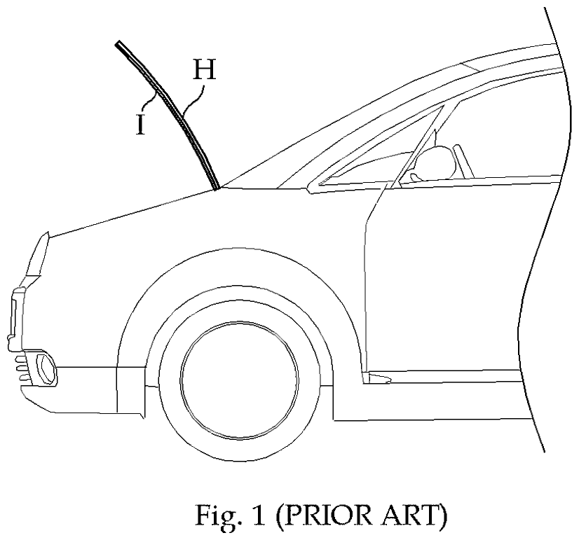

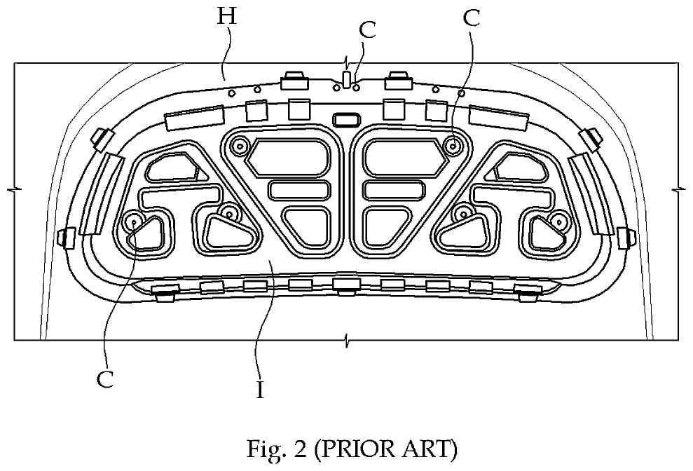

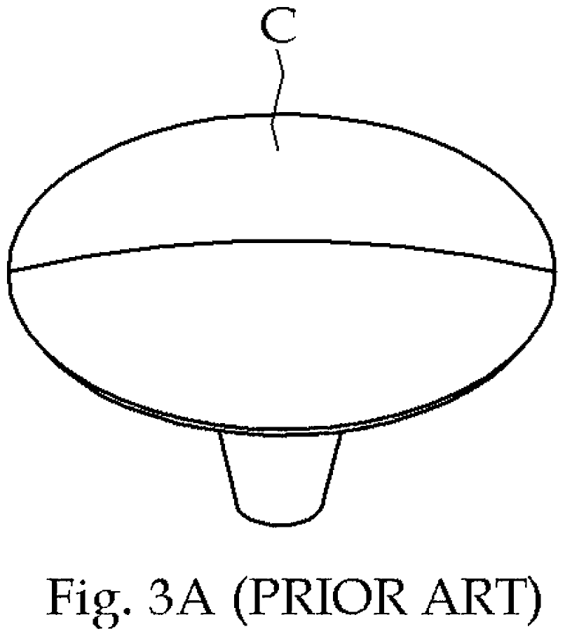

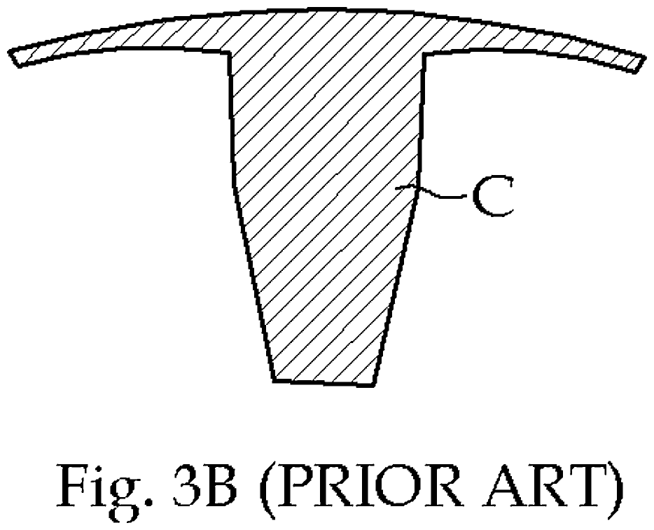

### DETAILED DESCRIPTION OF THE INVENTION

Hereinafter, embodiments of the present disclosure will be described in more detail with reference to the accompanying drawings. Prior to this, terms or words used in the present specification should not be interpreted as being limited to usual or dictionary meanings and should be interpreted as meanings and concepts corresponding to the technical spirit of the present disclosure according to the principle that the inventor may properly define the concepts of the terms in order to describe his/her own invention in the best way.

Thus, since the embodiments described in the present specification and configurations illustrated in the drawings are merely the most exemplary embodiments of the present disclosure and do not represent all the technical spirit of the present disclosure, it should be understood that various equivalents and variations that may replace the embodiments and the configurations are present at filing of the present application.

Configuration of Bidirectional Clip

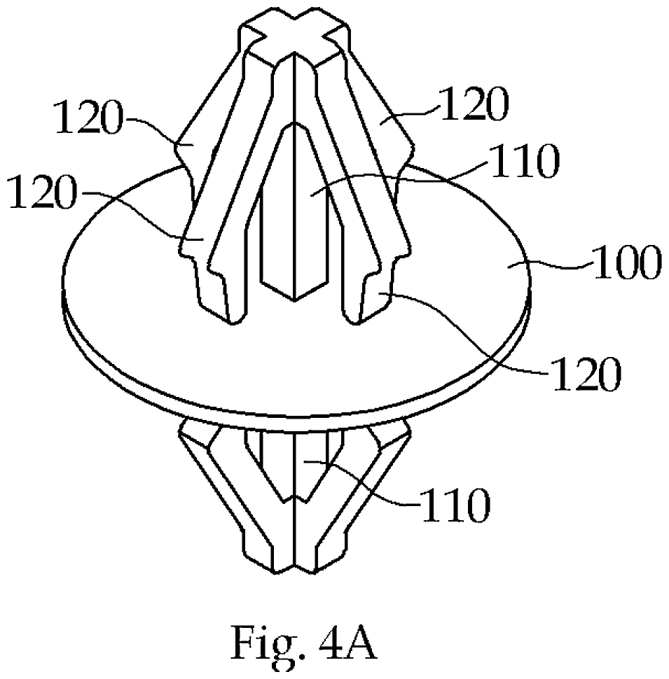

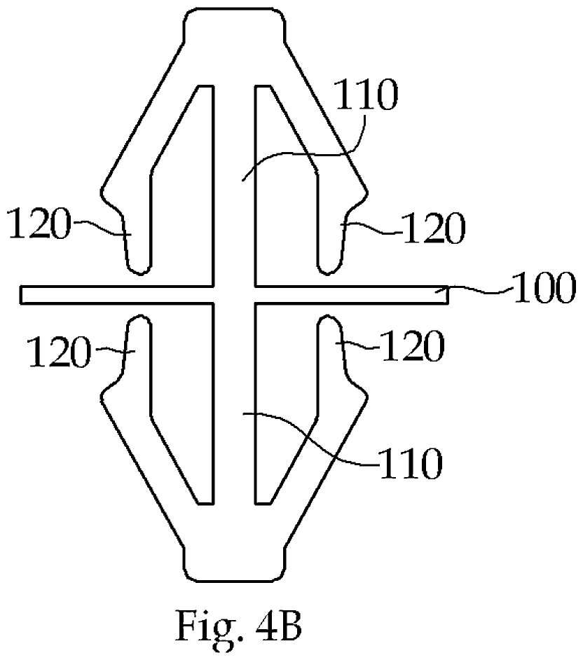

As illustrated in FIGS. 4 to 6, a bidirectional clip for a vehicle according to the present disclosure includes a base 100, two pillars 110 protruding from both surfaces of the base 100, and at least two elastic stopping protrusions 120 formed in each of the pillars 110.

In particular, the elastic stopping protrusions 120 protrude from both sides with respect to the base 100, so that a worker grips the bidirectional clip according to the present disclosure by hand in any direction and fits and fixes the clip in and to a member using the elastic stopping protrusions 120 in a convenient position.

Further, the elastic stopping protrusions 120 are manufactured such that an interval between the two adjacent elastic stopping protrusion 120 among four to six elastic stopping protrusions 120 with respect to the pillars 110 is the same. Thus, when the bidirectional clip according to the present disclosure is assembled with a mounting hole formed in a circular shape, the bidirectional clip can be easily and conveniently assembled and conveniently used in any direction regardless of an assembly direction and can be stably used for a long time because a coupling force is uniformly distributed.

Further, as the elastic stopping protrusions 120 are formed on both sides of the base 100, two members can be assembled by each being simultaneously coupled to both sides with respect to the base 100.

Hereinafter, these configurations will be described in more detail with reference to the accompanying drawings. Here, reference numeral “P” denotes a member to be assembled using the bidirectional clip according to the present disclosure in a vehicle (here, the dash panel is designated by reference numeral “P”), and reference numeral “0” denotes a mounting hole formed to assemble the bidirectional clip according to the present disclosure with the member.

A. Base

As illustrated in FIGS. 4 to 6, the base 100 is manufactured in a plate shape having a predetermined size.

In particular, the base 100 may be manufactured and used in any shape, but may be manufactured and used in a circular plate shape most preferably. When the member P is assembled using the bidirectional clip according to the present disclosure, a fastening force is distributed over a certain range around the pillars 110, which are formed at a center of the base 100 and will be described below. In this way, while the fastening force is uniformly distributed, and while the member P is not necessarily assembled according to the assembly direction when the bidirectional clip is used, the worker can conveniently assemble and use the member P without being injured.

As illustrated in FIGS. 4 to 6, the two pillars 110 are formed in the base 100.

B. Pillar

As illustrated in FIGS. 4 to 6, the two pillars 110 are each formed on both surfaces of the base 100.

In particular, as illustrated in FIGS. 4 to 6, the pillar 110 has the elastic stopping protrusion 120, which will be described below formed therein, and thus the bidirectional clip according to the present disclosure can be fastened on any side among both sides thereof.

Accordingly, in an embodiment of the present disclosure, as illustrated in FIGS. 4 to 6, the pillar 110 may protrude outward from the center of the base 100. This is for uniformly distributing the fastening force over a certain range from the center of the base 100, which is a center of the pillar 110.

Further, in an embodiment of the present disclosure, it is illustrated that the pillar 110 is formed in the form of a square pillar in the drawings, but the present disclosure is not limited thereto, and the pillar 110 may be manufactured in any shape, for example, a cylindrical shape, as long as the pillar 110 may stably support the elastic stopping protrusion 120, which will be described below.

As illustrated in FIGS. 4 to 6, the at least two elastic stopping protrusions 120 protrude from each of the pillars 110.

C. Elastic Stopping Protrusion

As illustrated in FIGS. 4 to 6, the elastic stopping protrusion 120 protrudes from a protruding end of each pillar 110 toward the base 100.

In this case, as illustrated in FIGS. 4 to 6, the elastic stopping protrusion 120 protrudes and spreads outward from the protruding end of the pillar 110 toward the base 100, the elastic stopping protrusion 120 is changed into the form of an arrowhead, and thus, when inserted into the mounting hole O formed in the member P, the elastic stopping protrusion 120 can be easily fitted and assembled.

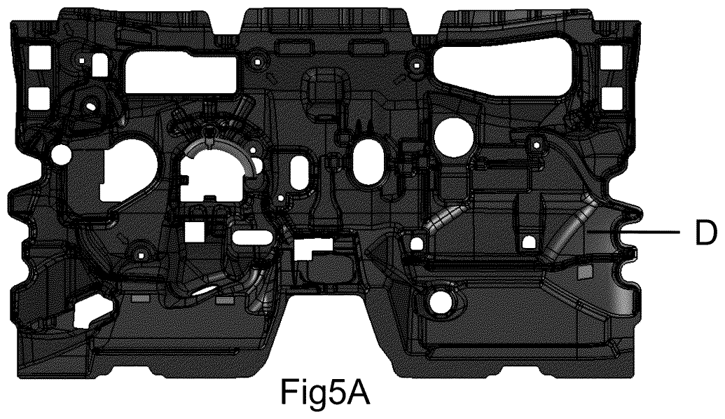

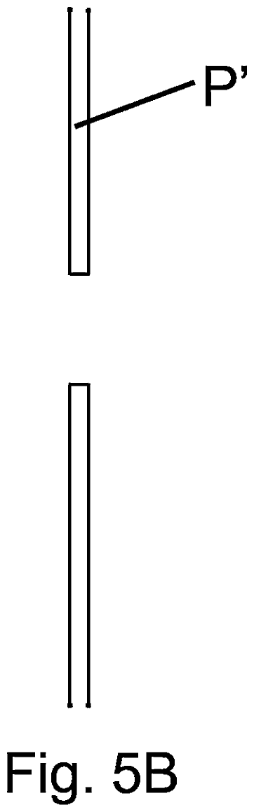

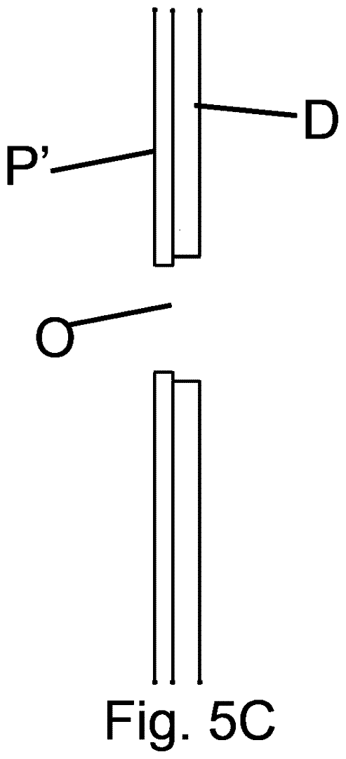

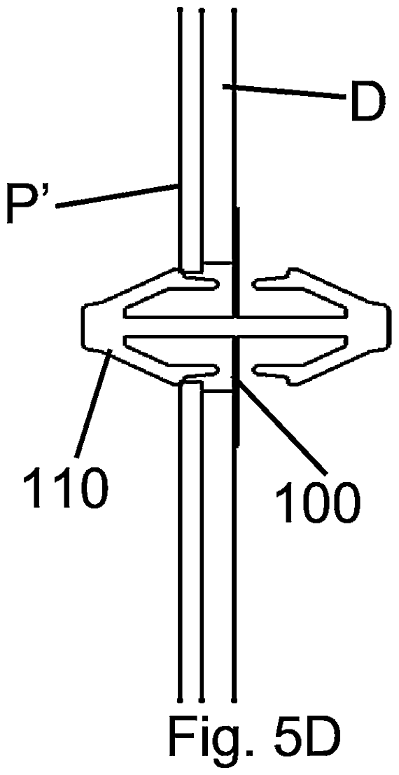

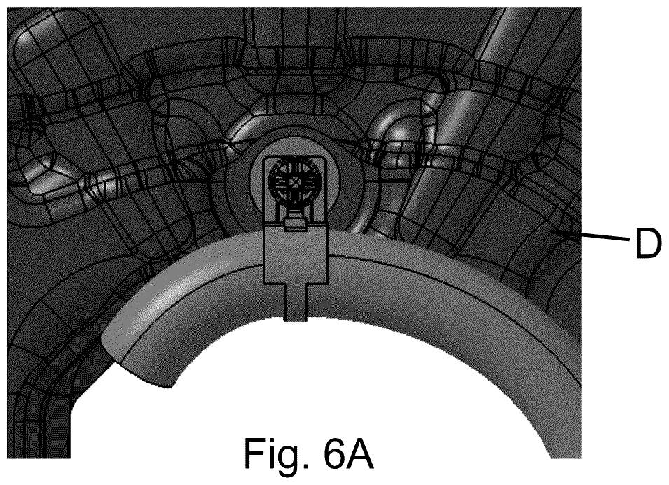

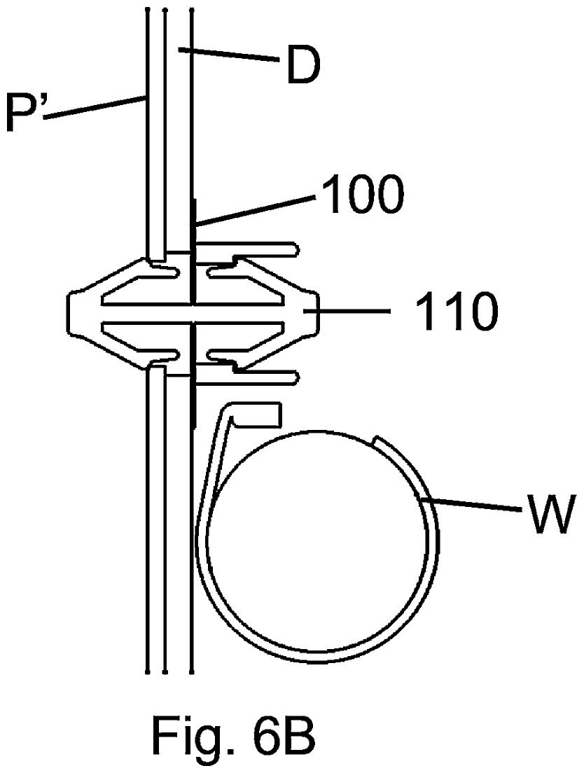

Further, as illustrated in FIGS. 5 and 6, the degree of spreading of the elastic stopping protrusion 120 around the pillar 110 may be wider than the mounting hole of the elastic stopping protrusion 120. When a dash insulator D is assembled with a dash panel P′ using the bidirectional clip according to the present disclosure, as the elastic stopping protrusion 120 is fitted in the mounting hole O, the elastic stopping protrusion 120 is deformed toward the pillar 110 by being caught by the mounting hole O. Further, the elastic stopping protrusion 120 is extracted from the mounting hole O to some extent, returns to an original state, and is caught by an edge of the mounting hole O, and thus a stopping operation is performed.

In an embodiment of the present disclosure, FIGS. 4 to 6 illustratively illustrate that four elastic stopping protrusions 120 are formed, but most preferably, four to six elastic stopping protrusions 120 are formed and the same interval is formed between two adjacent elastic stopping protrusions 120. The elastic stopping protrusion 120 may be fitted in and assembled with the mounting hole O regardless of a direction in which the elastic stopping protrusion 120 is fitted, and in an assembled state, a force applied to each elastic stopping protrusion 120 may be distributed to support the elastic stopping protrusion 120.

The bidirectional clip according to the present disclosure may be used to attach one component to another component. For example, the component is assembled with the another component using one of the two elastic stopping protrusions 120 as illustrated in FIG. 5 or using both the two elastic stopping protrusions 120 as illustrated in FIG. 6. That is, as illustrated in FIG. 5, after the dash insulator D is installed in the dash panel P′ to face the dash panel P′, one of the two elastic stopping protrusions 120 is forcibly fitted in the overlapping mounting hole O, and thus the elastic stopping protrusion 120 is narrowed and then spread to an original state to fix the dash insulator D to the dash panel P′. Further, as illustrated in FIG. 6, a counterpart component D may be fixed to a panel-shaped component P using the one elastic stopping protrusion 120, and another necessary component such as a wiring W may be forcibly assembled with the other elastic stopping protrusion 120 that is not used.

A bidirectional clip for a vehicle according to the present disclosure has the following effects.

(1) Since an elastic stopping protrusion is formed regardless of any side of the bidirectional clip being gripped, a member may be easily assembled in a desired position using the elastic stopping protrusion, and thus assembly efficiency can be improved.

(2) The bidirectional clip may also be used to fixedly assemble another member with each of the elastic stopping protrusions formed on both sides of the base, and thus is convenient.

(3) Even when one elastic stopping protrusion is bent or broken, the bidirectional clip may be used again using the elastic stopping protrusion formed on an opposite side, and thus is economical.

(4) As four to six elastic stopping protrusions are formed around pillars at regular intervals, when the elastic stopping protrusion is fitted in a mounting hole, and when the elastic stopping protrusion is easily aligned with the mounting hole regardless of an assembly direction and the clip is forcibly pressed, the assembly can be easily performed.

As described above, according to the present disclosure, the elastic stopping protrusions may be formed on both surfaces of the base and assembled in the mounting holes, and thus the worker can easily assemble the elastic stopping protrusions and the mounting holes in a convenient direction regardless of a direction in which the worker grips the bidirectional clip.

What is claimed is:

1. A bidirectional clip for a vehicle, comprising a base, wherein the base includes:
two pillars protruding outward from central portions of both surfaces of the base; and
at least two elastic stopping protrusions spread outward from ends of the pillars toward the base, the same interval being formed between the two adjacent elastic stopping protrusions with respect to the pillars.

2. The bidirectional clip of claim 1, wherein four to six elastic stopping protrusions are formed at regular intervals with respect to the pillars.
